(19) United States
(12) Patent Application Publication
(10) Pub. No.: US 2026/0336165 A1
(43) Pub. Date: Oct. 29, 2026

(54) Method and device for the continuous deodorization of granular plastics

(71) Applicant: ZEPPELIN Systems GmbH, Friedrichshafen (DE)

(72) Inventors: Hans SCHNEIDER, Lindau (DE); Marcus KOREHNKE, Weingarten (DE)

(21) Appl. No.: 19/120,562

(22) PCT Filed: Oct. 11, 2023
(86) PCT No.: PCT/EP2023/078243

§ 371 Date: Apr. 11, 2025

(30) Foreign Application Priority Data
Oct. 11, 2022 (EP) 22200981.3

(51) Int. Cl. B29B 13/02; B29B 13/00

(52) U.S. Cl. CPC B29B 13/02; B29B 2013/005

(57) ABSTRACT

The invention relates to a method for the deodorization of recycling granulates for the removal of volatile organic compounds (VOC) by means of heat and/or gas treatment in at least one deodorization silo (40, 41) with the following method steps:
1.1 Treating the granulates (62) in the deodorization silo (40, 41) at a deodorization temperature lying at or below the softening temperature of the granulates (62);
1.2 Maintaining the granulates (62) at the deodorization temperature;
1.3 Flushing volatile materials from the granulates (62) out of the deodorization silo (40,41) by flushing the product filling (36) in the deodorization silo (40, 41) by means of a heated flushing gas;
1.4 Cooling the granulates (62), wherein
the heating of process-input-side regranulates (62) in method step 1.1 takes place in a granulate heater (16) which obtains its process heat from an input-side recuperator (13), which is in turn heated by the waste heat from an output-side granulate cooler (5), or the hot waste air from the granulate cooler (5) is introduced directly into the granulate heater (16).

The invention relates to a method and a device for the continuous deodorization of granular plastics according to the pre-characterizing portion of claim 1.

A method mentioned hereabove is known from EP 2 635 609 B1. There, the product is heated with external energy before being filled into the deodorization silo, which is associated with high energy consumption, a factor which is to be avoided. For heating the granulates, EP 2 635 609 B1 uses a device that is separate from the deodorization silo and a further device arranged downstream of the outflow on the deodorization silo for cooling the outflow granulates. The energy in the waste air flow is, however, not reused, but rather simply filtered via an outflow filter and ultimately fed to a downstream thermal recycling unit, which should provide for a detoxification of the outflow exhaust gases, whereby additional electrical energy is consumed.

An energy-saving method sequence for heating and cooling the filling volume of the deodorization silo is not to be found in this publication.

This publication also lacks a reference to odor elimination during the treatment of regranulates. Such regranulates have residual impurities of foreign polymers and are therefore particularly critical to process. A continuous method for the treatment of such contaminated granulates (regranulates), known from EP 2 635 609 B1, is difficult to master and leads to inadequate results. Due to the melting points of the foreign polymers, which differ from the base granulate, such regranulates tend to form undesirable agglomerates, which can be readily mastered with the features of the invention.

A similar prior art can be found in WO2014090856A1. In this publication, the heated granulates is treated with nitrogen gas. An energy-saving heating of the granulates is not shown in either publication.

EP 2 635 609 B1 thereby already discloses the following method steps:
1. Method for the deodorization of recycling granulates (regranulates) for the removal of volatile organic compounds (VOC) by heat and/or gas treatment, in a deodorization silo with the following method steps:
1.1 Heating of the granulates in the deodorization silo to a deodorization temperature at or below the softening temperature of the granulates;
1.2 Maintaining the granulates at the deodorization temperature;
1.3 Flushing out of volatile materials in the granulates from the deodorization silo by flushing the product filling in the deodorization silo by means of a heated gas;
1.4 Cooling the granulates.

The invention is therefore based on the task of enabling improved degassing of recycled plastics granulates in continuous throughput operation with optimized equipment costs while saving significant process energy.

The invention provides a novel method and a device for carrying out the method in order to solve the problem set. According to the invention, in a preferred execution according to independent patent claim 1, it is now provided that the heating of process-input-side regranulates takes place in a granulate heater which obtains its process heat from an input-side recuperator, which is in turn heated by the waste heat from an output-side granulate cooler, or the hot waste air from the granulate cooler is introduced directly into the granulate heater.

A significant energy saving is achieved by heating the regranulates fed into the process with the waste heat of the granulates leaving the process.

The advantage of the technical teaching of claim 1 is that high-quality granulates can be obtained from the starting material with a more limited energy use, lesser mechanical effort, and a reliable mode of operation.

A further energy saving is achieved by the technical teaching of independent patent claim 4, which in a preferred design provides that the waste heat of the exhaust gas flow from the deodorization silos is used to heat the flushing gas for the deodorization silos.

This return of energy can save further, considerable quantities of energy.

The invention also describes novel device features in independent device claim 15 and claim 16.

In this manner, it is provided, according to independent patent claim 15, that the granulate heater receives its process heat from an input-side recuperator, which can be heated by the waste heat of the granulate cooler arranged on the output side.

According to independent patent claim 16, it is provided that the waste air of the one or plurality of deodorization silos can be fed via a silo waste air line to a recuperator which heats the flushing gas for the deodorization silos.

Both device claims describe novel recuperators which contribute in a particularly advantageous way to an energy saving by the granulate heater and also to an energy saving for heating of the flushing gas.

Using this technical teaching, the advantage is achieved whereby relatively large volumes of regranulates can now be continuously heated and cooled in a novel type of deodorization silo without the need to supply a large quantity of external energy.

The preferred method sequence according to the invention therefore has the advantage that high-quality granulates can be obtained from the input-side regranulates with more limited energy use, lesser mechanical effort and a reliable mode of operation.

The term “regranulates” is understood to refer preferably, but not exclusively, to PE-HD, PE-LD, PP as well as PS type plastics, which are fed back into the manufacturing process from lightweight packaging (LWP) waste.

### 1. Area of Application

1.2 Reduction of odors of recycling granulates (regranulates).
1.2.1 In the field of “post-consumer” plastics, these plastics are mainly of the PE-HD, PE-LD, PP and PS types, which plastics are fed back into the manufacturing process from the lightweight packaging (LWP) waste.
1.2.2 The reduction of odors after the manufacture of plastics compounds (admixtures of additives and fillers).

### 2. Features of the Invention

The overall system uses a modular construction and consists of a plurality of subsystems (modular concept).
It is a compact system that can be flexibly adapted to the assembly site.
Separation of the granulate treatment method steps into: 1. Heating; 2. Degassing; 3. Cooling.
This ensures that there is always a flexible adaptation to the requirements of the input bulk material in terms of degassing temperature, degree of dilution (fan setting) & duration of the retention time (silo operation).
Very high process safety & high quality of the granulates.
Possibility of later system expansion (for example, additional deodorization silos, increased fan capacity, blowers, etc.).
Flexibility in the choice of energy types for heating (electric, gas, steam).
Operating costs can be optimized (for example, gas price).
The “heating” method step leads to a reduction in silo height thanks to a novel type of deodorization silo, since the bulk material preheating in the silo is no longer necessary (heating layer required).
Increase in the retention time with a given hall ceiling height leads to higher granulate quality.
Condensation in the deodorization silo is avoided in the “heating” method step, since the bulk material enters the deodorization silo already preheated, so there is no condensed volatile matter in the system.
Reduction in energy consumption through thermal insulation and energy recovery via the recuperators.
A more compact & highly efficient cross flow heat exchanger for bulk materials.
No undesirable bulk material changes during deodorization.
Prevention of bulk material agglomerates.
Closed system. No impairment of the bulk materials due to external environmental influences (impurities, etc.).
Easy cleaning of the entire system and the components & assemblies.
Short delivery, installation and commissioning times.
Cost-effective design and therefore attractive price.

### 3. Various System Executions

3.1 Maximum instance A:
3.1.1 There are two deodorization silos present. Energy recovery takes place downstream of the deodorization silos and during granulate heating via the waste heat return, according to the invention, from the granulate cooling, reduction of the quantity of waste air during heating & direct return of the heating gas). This has the following advantages:
   3.1.1.1 Faster batch changeover
   Example: deodorization silo 1 for residual emptying & deodorization silo 2 for new filling, simultaneous aeration of silos 1 & 2, thereby providing higher production output.
   3.1.1.2 More flexible process control
   Longer retention time possible, same bulk material in silos 1 & 2, increased process safety & high granulate quality.
   3.1.1.3 If the hall ceiling height is limited (extruder halls normally 8-10 m high), the required retention time can also be maintained using two “low” D-silos. Resulting in a reduction of the system costs of the “hall roof.”
   3.1.1.4 A return of the heating gas (heating) takes place towards the fresh gas intake filter and this leads to a reduction in the waste air volume in the waste air handling (thereby controlling the “concentration”).
3.2 Medium instance B:

1(One deodorization silo present, energy recovery downstream of the deodorization silo and during granulate heating through waste heat return from the granulate cooling.
3.3 Minimal Instance C:
Preliminary remark: All features and properties described below apply analogously not only to the minimal instance C, but also to the instances A and B.
3.3.1 In the minimal instance there is only one deodorization silo present. Energy recovery takes place downstream of the deodorization silo.
3.3.2 The system interfaces to other systems are defined. Clear interfaces are defined: bulk material feeding & removal, exhaust gas removal into the environment or for waste air treatment (for example, activated carbon).
This results in simple planning interfaces & low planning costs.
3.3.3 Compact system and at the same time flexibly adaptable to the assembly site.
Deodorization systems are possible as “stand alone” systems in new systems or as retrofits in existing systems as part of a “modernization.”
3.3.4 Closed system
There is no impairment of the bulk materials due to external environmental influences (impurities, etc.). This results in very high process safety with high granulate quality.
3.3.5 Thermal insulation: all system components are thermally insulated to save energy. This results in a reduction of the heat loss or respectively energy loss of the systems.
3.3.6 Energy recovery: Use of recuperators (preferably air/air heat exchangers). The waste heat, for example, downstream of the deodorization silo or from the cooling unit, is fed back to the heating units. Resulting in:
   3.3.6.1 Significant reduction in energy costs.
      Result: Reduction in operating costs (>30 %).
   3.3.6.2 Reduction of size & costs of heater.
      Result: Reduction in system costs.
3.3.7 The energy content of the preheated granulates (downstream of the outflow from the extruder) is used. The warm granulate grains reduce the energy consumption of the entire system.
3.3.8 More compact & highly efficient cross flow heat exchanger for bulk materials. Resulting in:
   3.3.8.1 higher flow velocities onto the granulates are possible compared to the silo fixed bed. Resulting in:
   3.3.8.2 greater and therefore faster heat transfer during heating & cooling;
   3.3.8.3 smaller size and lower acquisition costs.
3.3.9 First in/first out=>all granulates have the same retention time in the granulate heater or granulate cooler. Resulting in means that there are no extremely hot surfaces, as is, for example, the case with plate heat exchangers, since air is used as the heating medium.
   3.3.9.1 Gentle heating/no hot spots. Resulting in very high process safety
   3.3.9.2 with high granulate quality.
3.3.10 Heating medium air (Plug & Play/only socket required.
   Theoretically, no cooling water is required (using cooling water is too complex and often problematic).
   3.3.10.1 Simple heating/cooling method
   3.3.10.2 with low acquisition costs.
3.3.11 All conveying lines preferably have a roughened surface.

This prevents angel hair, which, for example, has built up in the pipe line during the conveying of batch A (low melting point) and is then detached during conveying of batch B (high melting point). This prevents a carryover of product from batch A to batch B, which results in high product quality.
3.3.12 Prevention of melting of residual quantities of batch A (low melting point) during operation of batch B at higher temperatures.
   3.3.12.1 This results in very high process safety & reduction of system costs (cleaning).
   3.3.12.2 A small conveying line for recirculation is present at the deodorization silo(s).
3.3.13 Safe operation if there is no removal from the deodorization silo(s). In this case, the bulk material is “circulated” (recirculated). This prevents the formation of agglomerates and the subsequent discharge & outgoing conveyance from the silo(s) is ensured at all times. This results in very high process safety with high granulate quality.
3.3.14 Optional additional instance “steam stripping”
Water vapor in the degassing flow improves heat transfer and diffusion. This results in greater and therefore faster heat transfer during heating and cooling.

### 4. Performance and Advantages of the Invention

The invention focuses on the reduction of the odor of recycling granulates (regranulates).

As already laid out above, in the field of “post-consumer” plastics these recycling granulates are mainly PE-HD, PELD, PP and PS types of plastics, which are fed back into the manufacturing process from the lightweight packaging waste (LWP). Using the technical teaching of the invention, the odor reduction of PET or PVC type regranulates is also provided for when using modified method parameters and device features.

In the case of the regranulates considered here, the not easily volatilized, long-chain odorous substances that have diffused, for example, into the plastics are removed.

### 5. Function of the Deodorization System

5.1 In a thermal cleaning process, the regranulates or the plastics compounds are purified of odors (volatile organic compounds VOC). In so doing, in the first step, the granulate is gently heated to just below the softening temperature using a cross flow heat exchanger configured as a granulate heater. The degassing with hot air subsequently takes place in a separate deodorization silo in the second step. The cooling of the granulate to a temperature suitable for the downstream system, takes place in the third step in a heat exchanger configured as a granulate cooler. In so doing, very high-quality plastics granulates are produced.

This opens up new application possibilities for the manufacture of higher-quality regranulates that were previously only possible with virgin materials, thus resulting in higher turnover, market expansion, and higher sales revenues.

A very good and stable granulate quality is achieved for the residential, automotive, design, leisure, lifestyle and cosmetics sectors.
5.2 The regranulates & plastics compounds considered here are generally suitable for high-end products.
5.3 There are no undesirable bulk material changes during deodorization, resulting in a consistently high granulate quality.
5.4 No vacuum is required for the degassing of the plastics granulates in the deodorization silo. It follows that:
   5.4.1 No expensive and complicated system technology is required.
      Example: Avoidance of infiltration and ejection elements in a vacuum.
   5.4.2 The system and operating costs are thereby significantly limited.
5.5 Further additives are not required for additional reduction of odors.
   5.5.1 No further additives are necessary. The plant technology (dosing/weighing/ ...) that would be necessary is therefore not required.
   The system and operating costs are thereby significantly limited.
5.6. Customer-specific design and layout with regard to deodorization temperature, bulk material mass flow, duration of the retention time, degree of dilution, and size of the deodorization silo(s) is provided.

### 6. Deodorization Temperature

The deodorization temperature is the point at which the degassing process takes place most quickly. The higher this temperature, the faster the volatile content can be removed from the granulates. In so doing, the softening temperature of the plastics must, however, be taken into account here.

The typical temperature ranges specified here should only be regarded as reference values.

The layout of the individual temperature ranges takes place according to the product requirements:
LDPE: 95-100 °C
HDPE: 115-120 °C
PP (low): 90 °C
PP (high): 135 °C
POM: 140 °C

### 7. Bulk Material Mass Flow

Preferred parameters are 1 t/h, 2 t/h, 4 t/h-Y.

Larger mass flows Y are possible without any problems, due to the modular design principle. Customized layout according to product requirements.

### 8. Duration of the Retention Time

Preferred parameters are X, 8 h-12 h, Y.

Shorter X and longer retention times Y are possible without any problems due to modular design principle.

Customized layout according to product requirements.

### 9. Degree of Dilution Deodorization

Preferred parameters are X, 0.4-2.0, Y [kg granulate/kg air].

Smaller Y or higher degrees of dilution X are possible without any problems due to modular design principle.

Customized layout according to product requirements.

10. Dimensions of the deodorization silo(s) resulting from the parameters: mass flow, duration of the retention time & degree of dilution with a preferred gross volume of 18-200 m3 to Y.

Larger deodorization silo Ys are easily possible thanks to the modular design principle.

Customized layout according to product requirements.

### 11. Advantages

Flexibility starting with the system layouts;
Cost-optimized overall system;
Customized layout according to customer requirements;
Very high process safety & high granulate quality;

The deodorization system can be individually laid out to granulate specifications or respectively product requirements.

### 12. Quality of Degassing

The cleaning efficiency of recycling processes is evaluated by means of a challenge test.

A challenge test evaluates the cleaning efficiency of recycling processes with regard to migration-relevant post-consumer substances. Such a test is required, for example, in the bottle-to-bottle recycling of used PET bottles. The challenge test is also used to optimize recycling processes and can be applied to single-variety recycling material.

### 13. Quality of the Overall System

The overall system “DEO-C-deodorization system-Continuous” is a system based on a modular “building block concept” and consists of several subsystems.
13.1 The separation of the granulate preparation method steps according to the invention by
1. Heating up,
2. Degassing,
3. Cooling
leads to a standardization of the systems due to the associated flexibility. This results in a reduction in time and costs for project planning and for manufacturing, installation and commissioning. The system or respectively operating costs are thereby significantly limited. This results in short delivery times from order to commissioning.

### 14. Safety

14.1 High mechanical safety during operation of the entire system: no moving parts are accessible when installed.
This results in a high level of operational safety for the operating personnel and limited personnel downtime costs.

### 15. Preferred Process-engineering Framework Conditions

This process description defines the method engineering mode of operation of a continuous deodorization system, including the operating states and permissible operating windows to be monitored and controlled.

Deodorization systems can, for example, be used as “stand alone” systems in new systems, but can also be retrofitted in existing systems as part of a “modernization”. The plastics granulates are fed continuously into the deodorization system (for example, extruder outgoing conveyance). The deodorization removes volatile organic compounds (VOCs) from the plastics. The plastics granulate is initially heated to the required process temperature (deodorization temperature). The granulate is subsequently flushed with air or a suitable gas for a certain retention time in a deodorization silo. The air absorbs the volatile foreign substances. Lastly, the product is cooled for further processing/transport. The deodorization system can be laid out in a variety of variants. Better efficiency is achieved through energy recovery and thermal insulation.

The bulk densities of the plastics granulates, for example, the regranulates, are between 500 kg/m³-600 kg/m³. A typical batch size for continuous normal operation with product supply from the extruder is around 150 to 300 t/batch with a maximum mass flow of 2000 kg/h. Of course, smaller product mass flows of around 600 kg/h are just as achievable as are larger throughputs.

In general, the system layout is based on the required product mass flow, the bulk material properties and therefore the required process temperature (deodorization temperature) for fast and reliable degassing. The partial flow return depends on the desired or maximum permissible concentration of the waste air. The frequency of a batch change or the batch size itself must also be taken into account. Of course, energy recovery is playing an increasingly important role.

The charging of the deodorization system can be handled by gravimetric (gravity) or pneumatic conveying, preferably in roughened conveying lines in suction or pressure mode. Frequently, charging takes place with the aid of pneumatic dilute phase conveying with a maximum conveying air speed of 28 m/s.

The product temperature downstream of the extruder and before entry in the deodorization system is normally between +45 °C and +60 °C.

The deodorization system is generally suitable for PE-HD, PE-LD, PP and PS plastics granulates. The maximum permissible temperature in the process is however dependent on the bulk material.

Contamination of plastics types with each other should be precluded or respectively minimized. If plastics types with lower softening temperatures (LDPE, PS, etc.) are mixed in with plastics types with higher softening temperatures, at higher temperatures agglomerates may form. In this case, caking and blockages cannot be ruled out.

All conveying lines preferably have a roughened surface. This prevents angel hair, for example, from building up in the pipe line during the conveying of batch A (low melting point), and detaching during the conveying of batch B (high melting point). This prevents a carryover of product from batch A to batch B.

The subject matter of the present invention results not only from the subject matter of the individual patent claims, but also from the combination of the individual patent claims with each other.

All the information and features disclosed in the documents, including the abstract, in particular the spatial configuration shown in the drawings, could be claimed as essential to the invention insofar as they are novel, individually or in combination, compared to the prior art. The use of the terms “essential” or “according to the invention” or “essential to the invention” is subjective and does not imply that the features so designated must necessarily form part of one or more claims.

The invention is explained, hereinafter, in more detail on the basis of drawings illustrating several execution paths. Further features and advantages of the invention that are essential to the invention are apparent from the drawings and their description.

Wherein:

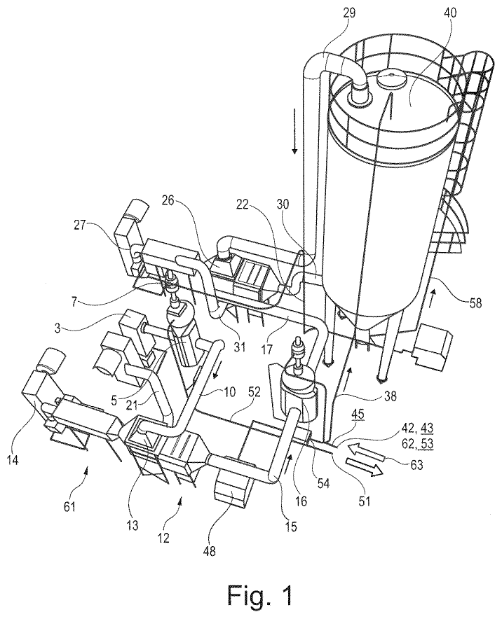

FIG. 1: Shows a schematic and simplified view of a first execution of a deodorization system.

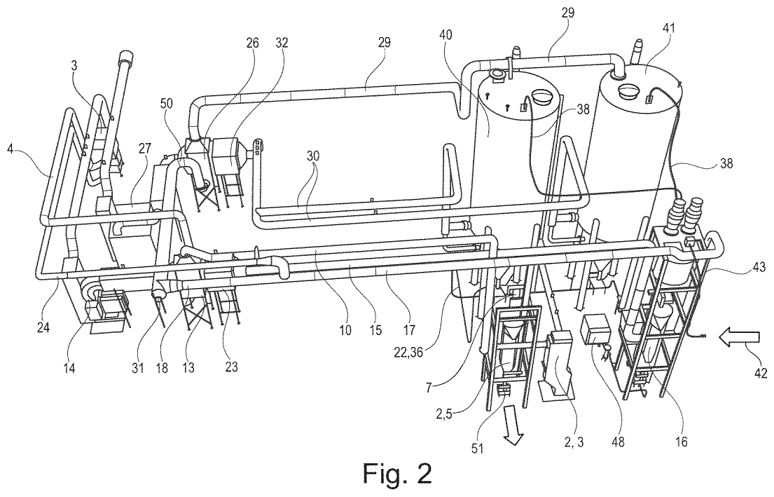

FIG. 2: Shows a second execution of a deodorization system.

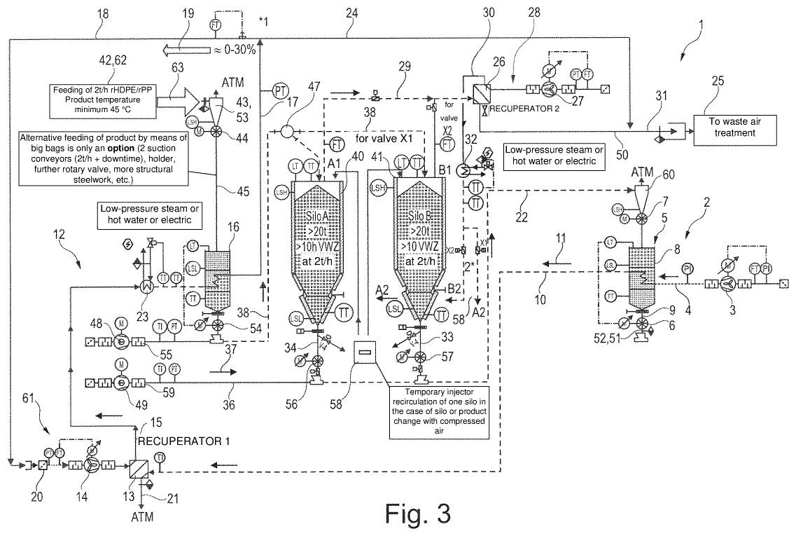

FIG. 3: Shows a method diagram of a fully equipped deodorization system.

Individual modules of the system are first described, followed by the method features, wherein the same reference symbols apply to the same parts.

### Feeding of Granulate (FIG. 1 to FIG. 3)

Main equipment: cyclone 43, storage container 53, rotary valve 44, granulate heater 16, rotary valve 54,

### Charging of Granulate From the Extruder (Normal Operation)

The regranulate 62 is continuously fed from the extrusion to the cyclone 43 in the direction of arrow 63 (see FIG. 4) between a minimum and a maximum mass flow (for example, 1,000-2,000 kg/h) by means of a pneumatic dilute phase conveying (for example, 500 m³/h). In normal operation (feeding of the regranulates 62 from the extrusion), the optional storage container 53 is operated in a continuous flow, which is to say, without granulate storage.

The rotary valve 44 runs at a higher rotational speed for this purpose.

A backflow/overfill brought about by a lack of/insufficient granulate removal of the downstream equipment is monitored by the fill level measurement in the cyclone 43. It stops the granulate feeding to the cyclone 43 or respectively to the optional storage container 53.

An interruption of the granulate feed of the extrusion is also necessary if the overfill protection in the optional storage container 53 is called into play.

### Charging of Granulate by Means of Big Bags

Outside of normal operation (continuous feeding from the extrusion), granulate can optionally be fed from big bags by means of suction conveyors (not shown here) into the necessary storage container 53. In this case, the continuous fill level measurement and limit value detection in the optional storage container 53 serves as feedback to the operator/control system of the suction conveyor device as to when the big bag emptying should be stopped or alternatively resumed in a timely manner. This is necessary for a continuous feeding of the regranulate 62 for product heating. The mass flow for supplying the system with big bags is normally reduced. The granulate input temperature from the big bags is lower than with continuous feeding of the “hot” extrusion.

### Granulate Heating

Main equipment: granulate heater 16, rotary valve 54, filter unit 20, fan 14, recuperator 13, air heater 23

The granulate heater 16 requires a minimum fill level of the regranulates 62 in the upper area in order to function/provide the heating power. This is ensured by the continuous fill level measurement in the inlet area of the granulate heater 16 and the resulting rotational speed adjustment of the rotary valve 54 at the exit.

Downstream of the fan 14, the air on the pressure side is preheated by the recuperator (air/air heat exchanger) 13 and subsequently heated further in the air heater 23. The target temperature of the heating air is regulated, for example, by controlling the supply of steam in the air heater 23. The target temperature, which is product-dependent, must not be exceeded in order to prevent an overheating/softening of the granulate in the granulate heater 16. An excessively high air temperature can lead to (local) softening and agglomeration of bulk material in the granulate heater 16 and can significantly disrupt the process. In another design, the recuperator 13 can be omitted and the hot—preferably filtered—waste air of the granulate cooler 5 can be fed directly into the hot gas line 15, whereby the granulate heater 16 is heated directly by the waste heat of the granulate cooler. In this case, the air treatment unit 61 could be omitted.

### Conveying of the Granulate Heating to the Deodorization Silos

Main equipment: blower 48, safety filter 55, switch 47, rotary valve 54, deodorization silo 40 & 41

Only one of the two deodorization silos 40 or 41 can be filled at the same time.

### Deodorization Silos and their Supply of Air

Main equipment: deodorization silo 40 & 41, fan 27, recuperator 26, air heater 32, rotary valves 56 & 57, injector redirection 22, granulate cooling 5.

### Normal Operation

In continuous normal operation, one of the two deodorization silos (40 or 41) is filled with granulate and simultaneously emptied via the rotary valve 56 or 57. For example, in this case, with a mass flow of 2 t/h and a maximum silo content of 20 t, a single granulate grain in a stable granulate layer in a bulk material fixed bed will slowly move through the silo 40, 41 from the top entry to the bottom exit over a period of 10 hours. To achieve and control the retention time of the granulate in the deodorization silo 40 or 41, the fill level in the silo must be kept constant. The defined retention time in standard operation is 10 h in this case. The adjusted normal state is a silo with an approximate minimum of 95% filling. The assurance of the required fill level in the deodorization silo is ensured by adjusting and regulating the rotational speed of the discharge valves 56 or 57.

The deodorizing air is supplied by means of the fan 27 and is preheated by means of the recuperator (air/air heat exchanger) 26. The necessary quantities of deodorizing air are fed through valves (flaps) to the air injection points on the deodorization silos 40 & 41. The warm, odor-contaminated waste air from the deodorization silos 40, 41 is fed back to the recuperator 26 (energy recovery according to the invention) and then passes into a waste air treatment unit.

Deodorization air temperature: The setpoint can be adjusted depending on the product. The actual value must be controlled and monitored by means of the steam supply control of the air heater 32 and the air temperature measurements. This is critical to the process. Too high an air temperature can lead to (local) softening and agglomeration of product in the silo (and thus to clogging of the silo discharge).

### Temporary Operating States

A disturbed outgoing conveyance requires a redirection:

A retention of hot granulate without being discharged from the deodorization silo 40 or 41 is only permissible for a short time (approx. max. 30 minutes), since agglomerates (may) form in the unmoved bulk material fixed bed of the deodorization silo. To avoid this, the temporary injector redirection 22 must be operated with a low mass flow rate (for example, 200-250 kg/h-if necessary, intermittently for at least 30 minutes at a time) to activate the bulk material fixed bed.

In the case of a longer standstill of the contents of the silo with hot granulate, the temperature of the deodorizing air must also be lowered significantly. This does not replace the injector redirection 22 until a sufficiently low granulate temperature is reached in the entire silo in order to prevent an agglomeration of the granulate due to high temperatures and fill pressure in the unmoved bulk material bed (fixed bed).

### Switching Between Deodorization Silos 40 and 41

The controlled transition from one deodorization silo 40, 41 to the other is only provided during batch/product changes. During this transition period, the granulate from the silo that is no longer continuously filled is discharged from the silo in a controlled manner and pneumatically conveyed for granulate cooling 5 or packaging (for example, max. 2,000 kg/h). At the same time, the second deodorization silo is now filled. During this transitional period, the deodorization air volume must be subdivided between the two deodorization silos (for example, based on the respective granulate filling per silo).

### Discharge Conveying From the Deodorization Silos 40, 41

Main equipment: deodorization silo 40 & 41, blower 49, safety filter 59, rotary valves 56 & 57, cyclone 60, granulate cooler 5.

In normal operation, one of the two deodorization silos 40 or 41 is continuously filled and simultaneously emptied.

Granulate cooling

Main equipment: cyclone 60, optional rotary valve 7, granulate cooler 5, rotary valve 6, fan 3, recuperator 13.

The granulate cooler 5 requires a minimum fill level of the granulate in the upper area in order to function/provide the cooling capacity. This is ensured by the continuous fill level measurement in the inlet area of the granulate cooler 5 and the resulting rotational speed adjustment of the rotary valve 6 at the exit.

The granulate exit temperature is monitored and an alarm is triggered if a limit value is exceeded. The quantity of cooling air of fan 3 is kept constant. Rotational speed control and air volume measurement compensate for different intake air temperatures. For optimum heat recovery, the air flow heated in the granulate cooler 5 is used in the gas line 10 for heating of the granulate at the beginning of the deodorization system. In the recuperator (air/air heat exchanger) 13, the waste heat is transferred to the gas volume flow for the downstream granulate heater 16. The air flow in the gas line 10 is subsequently released into the atmosphere.

### Conveying to Storage/Packaging

Main equipment: granulate cooler 5, rotary valve 6

The product from the granulate cooler 5 is transferred via the rotary valve 6.

A preferred design of the system is elucidated in more detail hereinafter using the system diagram in FIG. 3.

The deodorization system 1 consists essentially of a cooling branch 2 on the output side, in which the process-leaving hot granulate 8, which leaves the one or plurality of deodorization silos 40, 41, is cooled by fresh air, which is introduced by a fan 3 via the line 4 into the granulate cooler 5 and flows through the hot granulate 8. This results in the creation of a hot air flow at the outflow of the granulate cooler 5, which is used via the gas line 10 to heat the recuperator 13 arranged on the input side, which in turn heats the granulate heater 16 on the input side, in which the regranulates entering the process on the input side are heated. An electric motor-driven slide valve is present as the product outflow of the granulate cooler 5, which slide valve enables controlled outgoing conveyance 50 of the finished granulates by means of the removal line 52 via a rotary valve 6.

As an example, it can be stated that two tons per hour of removal capacity are possible and the product temperature can be a maximum of +60 °C with a maximum cooling air intake of 30 °C.

Each deodorization silo 40, 41 has a so-called injector redirection 58, in which a portion of the granulates can be ejected from the outflow branch 33, 34 upstream of the respective rotary valve, 56, 57, in order to be conveyed back into the ceiling area (input) of the respective silo 40, 41 via separate lines.

A motor-driven slide valve is arranged at the outflow of the deodorization silo 40, 41, which conveys a continuous quantity of hot granulates to the rotary valves 56, 57 via the product outflow 33, 34. If two deodorization silos 40, 41 are present, the rotary valves 56, 57 can convey the respective granulate either in parallel together or individually one after the other into the hot granulate line 22.

From the outflow of the two deodorization silos 40 and 41, the hot granulate is conveyed into the cyclone 60 via a hot granulate line 22 and an optionally-present rotary valve 7, wherein the air is separated from the hot granulate in the cyclone 60 in order to achieve a denser granulate bed.

The heating and flushing of the granulate bed located in the fixed bed in the interior of one or both deodorization silos 40, 41 with a hot flushing gas takes place via a flushing gas line 30 in each case, which opens into the cone area of the respective deodorization silo 40, 41 and there generates a hot flushing gas flow passing through the granulate bed.

The air required for the hot flushing gas is drawn in from the atmosphere by means of a fan 27 and passed through a recuperator 26 for heating, which recuperator is heated by the waste air which originates from the silo waste air line 29.

A preheating of the flushing gas thereby takes place in the recuperator 26 and flows into the cone area of one or both of the deodorization silos 40, 41 via a flushing gas line 30, which may additionally also have an air heater 32, preferably operated with external electrical energy.

The air heater 32 is optionally present and can eventually also be omitted.

Accordingly, the hot flushing gas is blown into the cone area of the two deodorization silos 40, 41 via the flushing gas line 30 according to the arrow symbols A2 and B2, selectably either in parallel or one after the other.

In the cone area, this results in the creation of an upwardly directed heat column of heated flushing gas—which rises in the granulate to be flushed—which flows through the entire granulate. The flushing gas line 30 allows a bifurcation either in parallel operation to both deodorization silos 40, 41 or alternating operation, in which one deodorization silo 40 or 41 is supplied with hot air whereas the other deodorization silo 41, 40 is emptied and therefore not flushed with flushing gas.

The granulate feeding of regranulates 62 to be processed is described below.

From the product supply 42, where, for example, a product quantity of two tons per hour can be fed at a product temperature of 45 °C, the product is supplied to a cyclone 43, at the output of which a rotary valve 44 is arranged. The cyclone 43 is used to degas the supplied product in order to achieve the highest possible product density at the output of the rotary valve 44 on the feed line 45. The product fed in this way is directed into a granulate heater 16, which is preferably configured as a cross flow heat exchanger. The supply of energy for heating of the granulate heater 16 is provided via a line 15. An electrically operated air heater 23 can optionally be present in the line 15.

A significant energy saving in the generation of hot air in the gas line 15 for the granulate heater 16 is achieved by using a recuperator 13, which is heated by waste heat of the granulate cooler 5 arranged on the output side.

The waste heat of the granulate cooler 5 is fed via the gas line 10 to the recuperator 13, which uses this waste heat to heat the air flow on the input side of the gas line 15, which is fed through the granulate heater 16.

At the output of the granulate heater 16, the waste air cooled in the granulate heater 16 is either led to the outside via a waste air line 21 or fed via the waste air line 17 into a central waste air line 24, where it is fed to an exhaust gas aftertreatment 25 via the waste air line 31. Further energy savings are achieved by the fact that the waste air line 17 leaving the granulate heater 16 directs a still heated partial flow in the direction of arrow 19 into a return line 18, which flows into the air treatment unit 61 for the recuperator 13. With its upstream filter unit 20, the fan 14 arranged in the air treatment unit 61 thus generates preheating of the air for the air flowing in the hot gas line 15, which is fed to the granulate heater 16.

Accordingly, in a preferred design, only a preferred air volume of 0 to 30% is conveyed into the return line 18 via the waste air line 17, whereas the main part of the waste air from the waste air line 17 is conveyed into the central waste air line 24, where it is combined with the waste air of the deodorization silos 40, 41 via the line 50 and fed as exhaust gas line 31 to an exhaust gas aftertreatment 25.

The exhaust gas return from the waste air line 17 leaving the granulate heater 16 into the return line 18 to the input of the air treatment unit 61 is a preferred execution, which can also be omitted from application case to application case.

Another application case of the present invention then provides that the return line 18 is omitted and that the fan 14 draws in fresh air from the atmosphere by means of the filter unit 20, compresses it and feeds it into the gas line 15 through the preheating in the recuperator 13, wherein this bifurcation as a whole is referred to as heating branch 12, by means of which the hot air is fed into the granulate heater 60.

The granulate processed in the deodorization silos 40, 41 is fed by means of the outflow-side product outflows 33, 34 and the rotary valves 56, 57 into the outgoing conveyance line 36, which operates as a dilute phase conveyor.

To generate air on the outgoing conveyance line 36, a suitable air flow is generated, which flows through the outgoing conveyance line 36 in the direction of arrow 37. The air flow is generated by a blower 49, which draws in the air from the atmosphere via a safety filter 59 and compresses it in order to generate a suitable air flow with a suitable air volume and temperature for dilute phase conveying in the hot granulate line 22 adjoining the outgoing conveyance line 36.

It is noted that a preferred feature of the invention consists in that an energy savings, preferably in the range of 20 to 30% compared to conventional systems, is possible inasmuch as the waste heat of the granulate cooler 5 is fed via the gas line 10 to a recuperator 13 serving as air treatment unit 61, wherein this hot air flows through the recuperator 13 and is preferably guided outside via the waste air line 21.

This measure ensures that the fresh air selectively drawn in either from the atmosphere or via the return line 18 is already preheated.

As a result, the heating medium flowing via the gas line 15 in the heating branch 12 only requires a small quantity of electrical energy from the electric air heater 23 to heat the granulate heater 16, which can even be completely dispensed with in many application cases. This results in a significant saving in the amount of electrical energy that is required in conventional state-of-the-art systems.

In the invention, it is also preferred that the decisive units are pneumatically fed side by side, this applies in particular to the granulate heater 16 for the two deodorization silos 40, 41, as well as for the granulate cooler 5 arranged in the cooling branch 2.

By spatially arranging the aforementioned units 16, 40, 41, 5 next to each other, a side-by-side arrangement of such a deodorization system 1 is achieved in practice over a certain spatial area, inasmuch as the aforementioned aggregates are at approximately the same height and are connected to each other by pneumatic conveying means.

The invention is however not limited to the above. In another preferred design, it can be provided that the granulate heater 16 and the granulate cooler 5 are located at heights that are vertically different than, for example, the heights of the deodorization silos 40, 41, in such a manner that gravity conveying of the granulate occurs and not dilute phase conveying, as described in the above execution example using the example of the outgoing conveyance lines 36 and 22.

The side-by-side arrangement of the aforementioned aggregates 16, 40, 41, 5 primarily serves to reduce the installation height. If the reduction in the installation height is not important, it is also possible, for example, for the granulate heater 16 to be arranged above the deodorization silos 40, 41, whereas the granulate cooler 5 can be arranged at the same height as the deodorization silos 40, 41 above or below it.

In a simple embodiment, which has already been described in the general part, it is also provided that only a single deodorization silo 40 or 41 is present, which corresponds to the simplest system scheme C. Even in the case of one such deodorization silo 40 or 41 being present, a continuous throughput is possible, wherein product overlaps occur during product changes, which must then be eliminated or which need to be accepted.

The parallel operation of two deodorization silos 40, 41 therefore has the advantage that continuous throughput operation is also possible during batch changes because, for example, the degassing and processing of the granulate takes place in one deodorization silo 40, whereas the outflow of the hot granulate takes place in the other deodorization silo 41. This has the advantage that the hot granulate from the deodorization silo 41 can be used for the air treatment of the granulate in the deodorization silo 40, which also results in significant energy savings.

The difference in the invention from the prior art therefore consists in that a granulate cooler 5 is used in the cooling branch 2, which is preferably configured as an air heat exchanger, the waste air of which is used via the gas line 10 to preheat a recuperator 13 arranged in the air treatment unit 61, whereby significant energy is saved with regard to the preheating of air for the granulate heater 16.

It is advantageous that at the air conveying output of the granulate cooler 5 on the gas line 10, the approximate same temperature level is present as that required at the input from the granulate heater 16 on the line 15, for the granulate heating there. This is achieved with the recuperator 13 arranged between the gas lines 10 and 15, which is heated by the exhaust gases from the granulate cooler 5.

In summary, the invention has the following advantages and features when compared to the prior art:
1. The almost complete reduction of odors of recycling granulates (regranulates). In the field of “post-consumer” plastics, these plastics are mainly of the PE-HD, PE-LD, PP and PS types, which plastics are fed back into the manufacturing process from the lightweight packaging waste (LWP).
2. The almost complete reduction of odors after the manufacture of plastics compounds (admixtures of additives and fillers).
3. No undesirable bulk material changes during deodorization. Consistently high granulate quality.
4. Very high flexibility, starting with system layout all the way to commissioning of the system.
5. Customer-specific design and layout with regard to deodorization temperature, bulk material mass flow, duration of the retention time, degree of dilution, and size of the deodorization silo(s).
6. Energy-saving thermal insulation of all system components and the energy recovery via recuperators (air/air heat exchangers) 13, 26 significantly prevent heat or alternatively energy loss.
7. A more compact & highly efficient cross flow heat exchanger 5, 16 for bulk materials. Separation of the method steps: Granulate heating, degassing & cooling.
8. Reliable prevention of bulk material agglomerates in the deodorization silos 40, 41.
9. Process safe, cost-optimized overall system with a longer lifetime and longer service life.

### LIST OF REFERENCE SIGNS

1 Deodorization system
2 Cooling branch
3 Fan
4 Line
5 Granulate cooler
6 Rotary valve
7 Rotary valve
8 Bulk material
9 Outflow
10 Gas line
11 Arrow direction
12 Heating branch
13 Recuperator
14 Fan
15 Gas line (hot)
16 Granulate heater
17 Waste air line
18 Return line
19 Arrow direction
20 Filter unit
21 Waste air line
22 Hot granulate line
23 Air heater
24 Waste air line
25 Exhaust gas aftertreatment
26 Recuperator
27 Fan
28 Flushing gas branch
29 Silo waste air line
30 Flushing gas line
31 Exhaust gas line
32 Air heater
33 Product outflow
34 Product outflow
35
36 Outgoing conveyance line
37 Arrow direction
38 Hot granulate line
39
40 Deodorization silo
41 Deodorization silo
42 Product supply
43 Cyclone
44 Rotary valve
45 Feed line
46
47 Switch
48 Blower
49 Blower (hot)
50 Line
51 Outgoing conveyance
52 Removal line
53 Storage container
54 Rotary valve
55 Safety filter
56 Rotary valve
57 Rotary valve
58 Injector redirection
59 Safety filter
60 Cyclone
61 Air treatment unit
62 Regranulates
63 Arrow direction

1. A method for the deodorization of recycling granulates for the removal of volatile organic compounds by means of heat and/or gas treatment in at least one deodorization silo with the following method steps:
a) treating the granulates in the deodorization silo at a deodorization temperature lying at or below the softening temperature of the granulates;
b) maintaining the granulates at the deodorization temperature;
c) flushing volatile materials from the granulates out of the deodorization silo by flushing the product filling in the deodorization silo by means of a heated flushing gas;
d) cooling the granulates
wherein the heating of process-input-side regranulates in method step a) takes place in a granulate heater which obtains its process heat from an input-side recuperator, which is in turn heated by the waste heat from an output-side granulate cooler, or the hot waste air from the granulate cooler is introduced directly into the granulate heater.

2. The method according to claim 1, wherein the cooling of the cleaned granulates produced in method step d) at the output of the one or more deodorization silos takes place in the output-side granulate cooler, through which cool fresh air flows, which fresh air, after flowing through the hot granulate, is used at the output from the granulate cooler as a heated air flow via a gas line to heat the input-side recuperator, which recuperator is configured to heat the granulate heater arranged on the input side.

3. The method according to claim 1, wherein the regranulate is heated to the required deodorization temperature within a retention time by flushing using a flushing gas and the regranulate is subsequently flushed with a cooled flushing gas within a further retention time.

4. A method for the deodorization of recycling granulates for the removal of volatile organic compounds by means of heat and/or gas treatment in at least one deodorization silo with the following method steps:
a) heating the regranulates in the deodorization silo to a deodorization temperature which is at or below the softening temperature of the regranulates;
b) maintaining the regranulates at the deodorization temperature;
c) flushing out volatile materials from the regranulates from the deodorization silo by flushing the product filling in the deodorization silo means of a heated flushing gas;
d) cooling the regranulates,
wherein the heat from the waste air of the one or plurality of deodorization silos is used to heat the flushing gas.

5. The method according to claim 1, wherein, according to the first-in/first-out principle, preferably virtually all the granulate grains have the same retention time in the granulate heater and/or in the granulate cooler and/or in the deodorization silo.

6. The method according to claim 1, wherein melting of residual quantities of batch A (low melting point) is prevented during operation of batch B at higher temperatures.

7. The method according to claim 1, wherein, in order to avoid agglomerates, a redirection of the granulate bed in the deodorization silo takes place when there is no product outflow.

8. The method according to claim 1, wherein in a first step, the regranulate is gently heated to just below the softening temperature using a granulate heater configured as a cross flow heat exchanger, and in a second step, the degassing with hot flushing gas takes place in the separate deodorization silo and in a third step, the cooling of the granulate to a temperature suitable for the downstream system, takes place in a further granulate cooler configured as a heat exchanger, wherein high-quality plastics granulates are produced.

9. The method according to claim 1, wherein the process-input-side regranulate is continuously fed from an external extrusion to a cyclone between a minimum and a maximum mass flow by means of a pneumatic dilute phase conveyor.

10. The method according to claim 1, wherein selectively one single deodorization silo or two or a plurality of deodorization silos are present.

11. The method according to claim 10, wherein, if two or a plurality of deodorization silos are present, the deodorization silos are operated in parallel.

12. The method according to claim 10, wherein, if two or a plurality of deodorization silos are present, the deodorization silos are operated in alternating mode.

13. The method according to claim 1, wherein in continuous normal operation, the two deodorization silos are filled with granulates and simultaneously emptied by means of output-side rotary valves.

14. The method according to claim 1, wherein in the switch-over of operation between the deodorization silos the granulate from the deodorization silo which is no longer continuously filled is discharged from the deodorization silo in a controlled manner and pneumatically conveyed for granulate cooling or packaging and simultaneously the silo filling of the second deodorization silo takes place.

15. A device for the deodorization of recycling granulates for the removal of volatile organic compounds heat and/or gas treatment in at least one deodorization silo, wherein the regranulates can be heated to their deodorization temperature in a granulate heater, and wherein the heated regranulates can be conveyed into the at least one deodorization silo, wherein a granulate cooler is arranged at the product output of the at least one deodorization silo, and wherein the granulate heater receives its process heat from an input-side recuperator, which can be heated by the waste heat from the output-side granulate cooler, or that the hot waste air from the granulate cooler is fed directly into the granulate heater.

16. The device for the deodorization of recycling granulates for the removal of volatile organic compounds by heat and/or gas treatment in at least one deodorization silo, wherein the regranulates can be heated to their deodorization temperature in a granulate heater, and wherein the heated regranulates can be conveyed into the at least one deodorization silo, wherein a granulate cooler is arranged at the product output of the at least one deodorization silo, and wherein the waste air from the one or plurality of deodorization silos can be fed via a silo waste air line to a recuperator which heats the flushing gas for the deodorization silos.

17. The device according to claim 15, wherein an equalization of the granulate feeding to the granulate heater is carried by a rotary valve arranged at the outflow from the granulate heater.

18. The device according to claim 15, wherein preferably 90% of the partial waste air flow from the granulate heater can be fed via a filter unit as suction-side air quantity to a fan serving the air treatment unit.

19. The device according to claim 18, wherein downstream of the fan the pressure-side air can be preheated by the recuperator and can then be heated even further in an air heater.

20. The device according to claim 15, wherein only one of the two deodorization silos can be simultaneously filled.
